(19) United States
(12) Patent Application Publication
(10) Pub. No.: US 2007/0201787 A1
(43) Pub. Date: Aug. 30, 2007

(54) Sensor device

(76) Inventors: Graham Cross, Darlington (GB); Neville John Freeman, Tarporley (GB)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/606,529

(22) Filed: Nov. 30, 2006

Related U.S. Application Data
(63) Continuation of application No. 10/130,494, filed on Jun. 12, 2002, now abandoned.

(30) Foreign Application Priority Data
Nov. 18, 1999 (GB) 9927249.4

(51) Int. Cl. G02B 6/00

(52) U.S. Cl. 385/12

(57) ABSTRACT

The present invention relates to a sensor device for detecting the amount of or changes in chemical stimuli in a gaseous or liquid phase analyte (e.g. a microanalyte) having means for intimately exposing at least a part of the (or each) sensing element to the localised environment containing the chemical stimuli.

### CROSS REFERENCE TO RELATED APPLICATION

This application is a continuation of U.S. application Ser. No. 10/130,494 filed Jun. 12, 2002 entitled “Sensor Device.”

### BACKGROUND OF THE INVENTION

1. Field of the Invention

The present invention relates to a sensor device and method for detecting the amount of (e.g. concentration) or changes in a chemical, physical or biological stimulus of interest in a localised environment, in particular to a sensor device and method for detecting the amount of or changes in chemical stimuli in a gaseous or liquid phase analyte (e.g. a microanalyte).

2. Background Art

Generally speaking, it is known to make use of the evanescent field component of electromagnetic radiation incident on a waveguide structure (i.e. the field which extends outside the guiding region) to sense discrete changes in optical properties (see inter alia GB-A-2228082, U.S. Pat. No. 5,262,842, WO-A-97/12225 and GB-A-2307741). This method relies on “leakage” of optical signals from the waveguide structure into a sensing layer typically formed from an absorbent polymer. The evanescent component of the optical signal being guided by the waveguide structure is typically small leading to limited interrogation of the sensing layer.

Conventional sensor devices for the detection of a chemical stimulus in an analyte (e.g. a microanalyte) frequently fail to provide the level of sensitivity and robustness desired. These limitations are particularly apparent with nanolitre quantities of analyte (e.g. microanalytes such as reactants and products). WO-A-98/22807 (IMCO (1097) Limited et al) describes a sensing system in which analytes are simply passed over the surface of a sensor chip in a non-localised, somewhat indiscriminate manner.

### SUMMARY OF THE INVENTION

Based on the principle of interferometry (which itself is a well established technique), the present invention provides a sensor device which exhibits enhanced signal to noise ratio (sensitivity) by utilising the specialised architecture of a certain sensor component (e.g. a sensor chip) with means (e.g. a microstructure) for intimately exposing the sensor component to a chemical, physical or biological stimulus.

Thus viewed from one aspect the present invention provides a sensor device for detecting the amount (e.g. concentration) of or changes in a stimulus (e.g. a chemical, physical or biological stimulus) of interest in a localised environment, said sensor device comprising:

a sensor component including either (1) one or more sensing layers capable of inducing a measurable response to a change in the localised environment caused by the introduction of or changes in the stimulus of interest or (2) a sensing waveguide capable of exhibiting a measurable response to a change in the localised environment caused by the introduction of or changes in the stimulus of interest; and

means for intimately exposing at least a part of the (or each) sensing layer or the sensing waveguide to the localised environment.

The sensor device of the invention exhibits improved sensitivity and selectivity and is robust to ambient conditions thereby optimising the field of use.

The sensor component may permit precise measurements to be made either across the entire architecture or at discrete areas thereby enabling effective integration with the means for intimately exposing at least a part of the sensing layer or the sensing waveguide to the localised environment. Thus in a preferred embodiment, the means for intimately exposing at least a part of the sensing layer or the sensing waveguide to the localised environment is integrated onto the sensor component.

Preferably the means for intimately exposing at least a part of the sensing layer or the sensing waveguide to the localised environment is adapted to permit the continuous introduction of, an analyte containing a chemical stimulus of interest (i.e. a dynamic system). For example, it may permit the continuous introduction of the stimulus of interest in a discontinuous flow (e.g. as a train of discrete portions) into the localised environment. This may be achieved by capillary action or by a separate urging means.

Preferably the means for intimately exposing at least a part of the sensing layer or the sensing waveguide to the localised environment is adapted to induce chemical reactions in a static analyte containing a chemical stimulus of interest. In this sense, the system may be considered to be dynamic. Chemical reactions may be induced in any conventional manner such as by heat or radiation.

The means for intimately exposing at least a part of the (or each) sensing layer or the sensing waveguide to the localised environment may be a part of a microstructure positionable on the surface of and in intimate contact with the sensor component.

Preferably the microstructure comprises means for intimately exposing at least a part of the sensing layer or the sensing waveguide to the localised environment in the form of one or more microchannels and/or microchambers. For example, an analyte containing chemical stimuli may be fed through microchannels or chemical reactions may take place in an analyte located in a microchamber. An analyte containing chemical stimuli may be fed into the microchannels by capillary action or positively fed by an urging means.

In a preferred embodiment, the means for intimately exposing at least a part of the (or each) sensing layer or the sensing waveguide to the localised environment is included in a cladding layer. For example, microchannels and/or microchambers may be etched into the cladding layer. The cladding layer may perform optical functions such as preventing significant discontinuities at the boundary of the sensing waveguide or sensing layer(s) or chemical functions such as restricting access of certain species to the sensing waveguide or sensing layer(s). The cladding layer may be integrated onto the sensor component.

Preferably, the whole of or a portion of any additional functionality may be included in the cladding layer. In one embodiment, the sensing layer itself may be incorporated in the cladding layer (for example in the form of an absorbent material). Particularly preferably, the whole of the additional functionality may be provided in the cladding layer and include sensing devices such as for example quadrature electric field tracks or other microfluidic sensing devices. The cladding layer may incorporate an electromagnetic source (e.g. a laser) and/or means for detecting electromagnetic radiation (of the type detailed below). The cladding layer may incorporate a chemical separating means (e.g. an HPLC based device).

Preferably the sensor device of the invention is adapted so as to be usable in evanescent mode or whole waveguide mode.

Thus in a first embodiment of the sensor device, the sensor component includes one or more sensing layers capable of inducing in a secondary waveguide a measurable response to a change in the localised environment caused by the introduction of or changes in the stimulus of interest.

In this first embodiment, the sensor device is advantageously adapted to optimise the evanescent component so as to induce in the secondary waveguide a measurable optical response. The sensor component may comprise a plurality of separate sensing layers to enable changes at different localised environments to be detected.

In a preferred sensor device of the invention, the sensing layer comprises an absorbent material (e.g. a polymeric material such as polymethylmethacrylate, polysiloxane, poly-4-vinylpyridine) or a bioactive material (e.g. containing antibodies, enzymes, DNA fragments, functional proteins or whole cells). The absorbent material may be capable of absorbing a gas, a liquid or a vapour analyte containing a chemical stimulus of interest. The bioactive material may be appropriate for liquid or gas phase biosensing. For example, the sensing layer may comprise a porous silicon material optionally biofunctionalised with antibodies, enzymes, DNA fragments, functional proteins or whole cells.

In a preferred sensor device of the invention, the secondary waveguide comprises silicon oxynitride or silicon nitride.

In a second embodiment of the invention, the sensor component includes a sensing waveguide capable of exhibiting a measurable response to a change in the localised environment caused by the introduction of or changes in the stimulus of interest.

In this second embodiment, the sensor device is adapted to minimise the evanescent component and may be used advantageously in a whole waveguide mode.

In a preferred sensor device of the invention, the sensing waveguide comprises an absorbent material (e.g. a polymeric material such as polymethylmethacrylate, polysiloxane, poly-4-vinylpyridine) or a bioactive material (e.g. containing antibodies, enzymes, DNA fragments, functional proteins or whole cells). The absorbent material may be capable of absorbing a gas, a liquid or a vapour analyte containing a chemical stimulus of interest. The bioactive material may be appropriate for liquid or gas phase biosensing. For example, the sensing waveguide may comprise a porous silicon material optionally biofunctionalised with antibodies, enzymes, DNA fragments, functional proteins or whole cells.

Where the sensor component of the sensor device of the invention comprises a sensing waveguide adapted for use in whole waveguide mode, an absorbent layer in the form of an overcoating may be present for use as a membrane (for example) to separate out stimuli of interest.

To optimise the performance of the first embodiment, the sensor component may further comprise an inactive secondary waveguide in which the sensing layer is incapable of inducing a measurable response to a change in the localised environment caused by the introduction of or changes in the stimulus of interest. The inactive secondary waveguide is capable of acting as a reference layer. It is preferred that the secondary waveguide and inactive secondary waveguide have identical properties with the exception of the response to the change in the localised environment caused by the introduction of or changes in the stimulus of interest. By way of example, the secondary waveguide and inactive secondary waveguide is made of silicon oxynitride.

To optimise the performance of the second embodiment, the sensor component may further comprise an inactive (e.g. deactivated) waveguide substantially incapable of exhibiting a measurable response to a change in the localised environment caused by the introduction of or changes in the stimulus of interest. The inactive waveguide is capable of acting as a reference layer. The physical, biological and chemical properties of the sensing waveguide and inactive waveguide are as similar as possible (with the exception of the response to the change in the localised environment caused by the introduction of or changes in the stimulus of interest). Typically the inactive waveguide is made of silicon oxynitride.

Preferably each of the sensing waveguide or secondary waveguide (or any additional waveguides such as reference waveguides) of the sensor component is a planar waveguide (i.e. a waveguide which permits light propagation in any arbitrary direction within the plane).

Preferably, the sensor component of the sensor device of the invention constitutes a multi-layered structure (e.g. a laminated waveguide structure). In this sense, the sensor device is simple to fabricate and fault tolerant in terms of construction errors. In a preferred embodiment, each of the plurality of layers in the multi-layered sensor component are built onto a substrate (e.g. of silicon) through known processes such as PECVD, LPCVD, etc. Such processes are highly repeatable and lead to accurate manufacture. Intermediate transparent layers may be added (e.g. silicon dioxide) if desired. Typically the sensor component is a multilayered structure of thickness in the range 0.2-10 microns. A layered structure advantageously permits layers to be in close proximity (e.g. a sensing waveguide and an inactive (reference) waveguide may be in close proximity to one another so as to minimise the deleterious effects of temperature and other environmental factors). Preferably, the sensor component comprises a stack of transparent dielectric layers wherein layers are placed in close proximity. Preferably each layer is fabricated to allow equal amounts of optical radiation to propagate by simultaneous excitation of the guided modes in the structure. Particularly preferably, the amount of light in the sensing waveguide/inactive waveguide or in the secondary waveguide/inactive secondary waveguide is equal.

Preferably the sensor device comprises: means for measuring the response (to the change in the localised environment caused by the introduction of or changes in the stimulus of interest) of the sensor component.

The sensor device of the invention may advantageously be used to detect the amount of or changes in a chemical stimuli in an analyte which is introduced into the sensor device (i.e. a chemical sensor device). For example, a gaseous or liquid phase analyte comprising chemical stimuli may be introduced into the sensor device. Alternatively, a chemical reaction may take place which effects changes in the nature of the chemical stimuli in situ and causes a change in the localised environment.

The sensor device of the invention may be used to measure inter alia pressure, position, temperature or vibration in relation to the extent of or changes in a physical stimulus (i.e. a physical sensor device). The physical stimulus may be applied to the sensing layer or sensing waveguide of the sensor component via an impeller (for example) located on the sensing layer or sensing waveguide to enable the measurement of (for example) pressure or precise position.

Electromagnetic radiation generated from a conventional source may be propagated into the sensor component in a number of ways. In a preferred embodiment, radiation is simply input via an end face of the sensor component (this is sometimes described as “an end firing procedure”). Preferably (but not essentially), the electromagnetic radiation source provides incident electromagnetic radiation having a wavelength falling within the optical range. Propagating means may be employed for substantially simultaneously propagating incident electromagnetic radiation into a plurality of waveguides. For example, one or more coupling gratings or mirrors may be used. A tapered end coupler rather than a coupling grating or mirror may be used to propagate light into the lowermost waveguide.

The incident electromagnetic radiation may be oriented (e.g. plane polarised) as desired using an appropriate polarising means. The incident electromagnetic radiation may be focussed if desired using a lens or similar micro-focussing means.

Using electromagnetic radiation of different frequencies (either simultaneously or sequentially) varies the contributions of the various waveguides and may further enhance the utility of the sensor device.

Multimode excitation may provide useful additional information. By comparing the outer and inner areas of the interference pattern, it may be possible to determine the extent to which any refractive index change has been induced by changes in the thickness of the outer regions (i.e. the dimensional changes) and the degree to which it has been effected by physico-chemical changes in the inner regions (i.e. compositional changes).

By way of example, both the TE (transverse electric) and the TM (transverse magnetic) excitation modes may be used sequentially or simultaneously to interrogate the sensor device as described for example in International patent application (Farfield Sensors Limited) claiming priority from GB9927248.6. In this sense, the sensor device comprises: first irradiating means for irradiating the sensor component with TM mode electromagnetic radiation and second irradiating means for irradiating the sensor component with TE mode electromagnetic radiation. The relative phase changes of the two modes are used to identify and quantify the nature of the optical changes taking place in the sensing layer or sensing waveguide. For example, it may be possible to attribute changes in the effective refractive index of the sensing layer or sensing waveguide to specific changes in dimension (e.g. expansion or contraction) and/or composition. The relative phase changes of the two modes may also be used to identify such changes taking place in subsequent layers when more compact structures are employed. Conveniently, measurement of capacitance and refractive mode index of the two modes yields further information on changes occurring in the absorbent layer.

Electromagnetic radiation may be modulated (amplitude, frequency or phase for example) to provide additional information on the behaviour of the sensor device.

As a consequence of the introduction of or changes in a physical, biological and/or chemical stimulus in the localised environment (i.e. a change in the refractive index of material in the localised environment), changes in the dielectric properties (e.g. the effective refractive index) of the sensing waveguide or sensing layer occur. This causes a measurable optical response (i.e. a change in the transmission of electromagnetic radiation down the sensing waveguide (or waveguides) in whole waveguide mode or the secondary waveguide in evanescent field mode).

An interference pattern may be generated when the electromagnetic radiation from the sensor component is coupled into free space and the pattern may be recorded in a conventional manner (see for example WO-A-98/22807). In this embodiment, a measurable optical response of the sensor component to a change in the localised environment manifests itself as movement of the fringes in the interference pattern. The phase shift of the radiation in the sensor component (e.g. induced in the secondary waveguide in evanescent field mode or exhibited in the sensing waveguide in whole waveguide mode) may be calculated from the movement in the fringes. In turn, the amount of or changes in a chemical, biological or physical stimulus in the localised environment may be calculated from the phase shift.

The sensor component may be excited across its width and a two-dimensional photodiode array (or the like) may be used to effectively interrogate “strips” of the sensor component (e.g. an array sensor). This may be carried out across more than one axis simultaneously or sequentially to provide spatially resolved information relating to events on the surface of the sensor component.

The sensor component may be perturbed (e.g. thermally perturbed) to enable the sensor device to be biased such as is described in International Patent application (Farfield Sensors Limited) entitled “sensor assembly” and claiming priority from GB9927248.6.

Movement in the interference fringes may be measured either using a single detector which measures changes in the electromagnetic radiation intensity or a plurality of such detectors which monitor the change occurring in a number of fringes or the entire interference pattern. The one or more detectors may comprise one or more photodetectors. Where more than one photodetector is used this may be arranged in an array.

In an embodiment of the sensor device, the electromagnetic radiation source and one or more detectors are integrated with the device into a single assembly.

A plurality of electromagnetic radiation detector units (e.g. in an array) and/or a plurality of electromagnetic radiation sources may be used to measure in discrete areas of the sensor component simultaneously the responses to changes in the localised environment. Alternatively, the position of the electromagnetic radiation detector and electromagnetic radiation source relative to the sensor component may be changed to provide information concerning responses in discrete areas of the sensor component. For example, discrete responses to a change in the localised environment caused by the amount of the same or different stimuli may be measured in discrete areas of the sensor component. In the first instance, concentration gradients of the same stimulus may be deduced. In the second instance, discrete responses to changes in the localised environment may be measured in different regions. For this purpose, the preferred device makes use of the versatility of the evanescent mode and comprises a plurality of separate sensing layers or regions.

Conveniently, electrodes positioned in contact with a surface of the sensing layer or sensing waveguide enable capacitance to be measured simultaneously. The electrodes may take the form of either parallel plates laid alongside a plurality of planar waveguides or as an interdigitated or meander system laid down on the top and bottom surfaces of the sensing waveguide or sensing layer or adjacent to it. In the case of a meander system, the metal forming the electrode is responsible for absorbing excessive amounts of light and as such the capacitance is measured on an adjacent structure which is not utilised for optical measurement.

Viewed from a further aspect the present invention provides a kit of parts comprising: a sensor device as hereinbefore defined, an electromagnetic radiation source and one or more detectors in an array. Preferably the electromagnetic radiation source and one or more detectors are integral to the means for intimately exposing the sensor component to the localised environment.

The sensor device of the invention may be used to detect the introduction of or changes in a chemical, physical or biological stimulus. The interaction of the stimulus with the sensing waveguide or sensing layer may be a binding interaction or absorbance or any other interaction.

Viewed from a yet further aspect the present invention provides a method for detecting the amount (e.g. concentration) of or changes in a chemical stimulus of interest in an analyte, said method comprising:

providing a sensor device as hereinbefore defined;

introducing the analyte into the means for intimately exposing at least a part of the (or each) sensing layer or the sensing waveguide to the localised environment;

irradiating the sensor component with electromagnetic radiation;

measuring movements in the interference pattern; and

relating the movements in the interference pattern to the amount of or changes in the chemical stimulus of interest.

Preferably the method of the invention is carried out in evanescent or whole waveguide mode.

In a preferred embodiment, the method comprises: continuously introducing the analyte containing a chemical stimulus of interest. In a particularly preferred embodiment, the process comprises: continuously introducing the analyte containing a chemical stimulus of interest in a discontinuous flow (e.g. as a train of discrete portions).

Preferably the method further comprises: inducing a chemical reaction in the analyte which is static in the localised environment.

Preferably the method further comprises: calculating the phase shift from the movements in the interference pattern and relating the phase shift to the amount (e.g. concentration) of or changes in the chemical stimulus of interest. Methods for performing this calculation will be familiar to those skilled in the art. The phase shift data may be related to the amount (e.g. concentration) of or changes in the chemical stimulus of interest by comparison with standard calibration data.

Viewed from a still further aspect the present invention provides an apparatus comprising a plurality of sensor devices as hereinbefore defined arranged in an array.

Viewed from a yet still further aspect the present invention provides the use of a sensor device according to the first aspect of the invention for detecting the amount of or changes in a chemical, physical or biological stimulus of interest. Preferably the sensor device is used to detect the amount of or changes in a chemical stimulus of interest in an analyte (e.g. a microanalyte).

The term “optical” used herein means radiation of any wavelength in the electromagnetic spectrum capable or the selective absence of such radiation (such as in obscuration devices).

### BRIEF DESCRIPTION OF THE DRAWINGS

The present invention will now be described in a non-limitative sense with reference to the accompanying Figures in which:

FIG. 1 illustrates schematically an integrated embodiment of the sensor device of the invention (whole waveguide mode);

FIG. 2 illustrates in plan view the sensor chip and incident electromagnetic radiation of the embodiment shown in FIG. 1;

FIG. 3 illustrates schematically an integrated embodiment of the sensor device of the invention (evanescent field mode);

FIG. 4 illustrates schematically a non-integrated embodiment of the sensor device of the invention (whole waveguide mode);

FIG. 5 illustrates schematically a partially integrated embodiment of the sensor device of the invention (whole waveguide mode);

FIG. 6 illustrates schematically a partially integrated embodiment of the sensor device of the invention (evanescent field mode);

FIG. 7 illustrates an integrated embodiment of the sensor device of the invention (whole waveguide mode);

FIG. 8 illustrates an integrated embodiment of the sensor device of the invention (evanescent field mode); and

FIG. 9 illustrates in plan view multiple interrogation of a sensor chip of the sensor device of the invention.

### BEST MODE FOR PRACTICING THE INVENTION

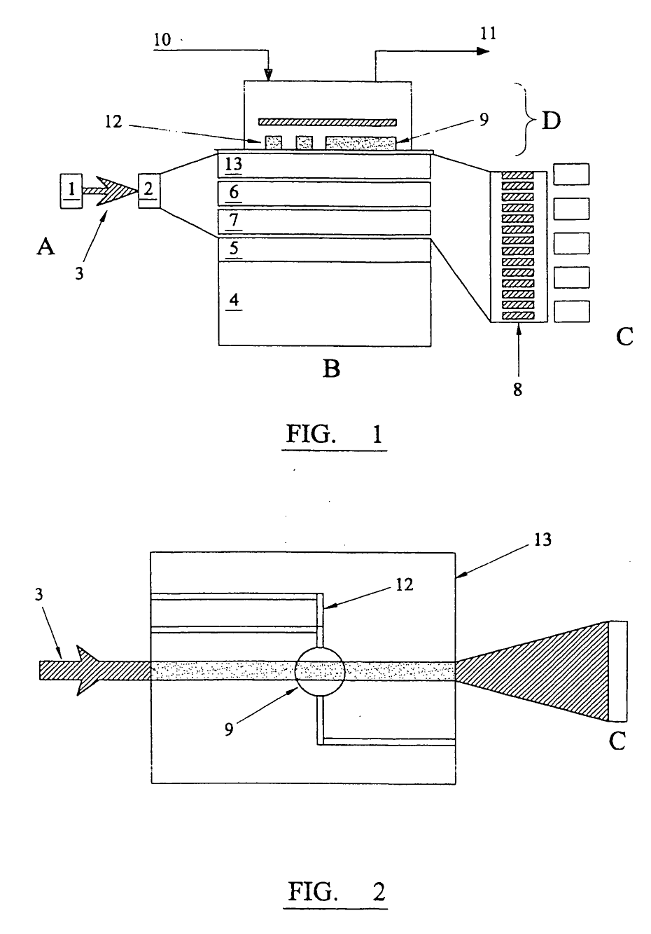

An embodiment of the sensor device of the invention is shown schematically in FIG. 1 in whole waveguide mode. The sensor device comprises a sensor chip B with a microstructure D integrated onto its upper surface.

Plane polarised electromagnetic radiation 3 is generated by an electromagnetic source (not shown). The electromagnetic radiation 3 is focussed using a lens 1 (or similar micro-focussing object) and oriented as desired using a polariser 2. The electromagnetic radiation passes into and through the multi-layered structure of the sensor chip B which in this embodiment comprises a silicon layer 4, silicon dioxide layers 5 and 6, a silicon oxynitride layer 7 and an absorbent layer 13. The silicon oxynitride layer 7 acts as the reference waveguide and the absorbent layer 13 as the sensing waveguide.

The electromagnetic radiation is transmitted into the sensing waveguide 13 and the reference waveguide 7 simultaneously. The layered structure of the sensor chip B is optimised so that the level of radiation entering the reference waveguide 7 is approximately the same as that entering the sensing waveguide 13. Having passed down the multi-layered structure of the sensor chip B, the output radiation is coupled into free space thereby generating an interference pattern 8.

The sensor chip B and integrated microstructure D allow an analyte containing stimuli of interest to be brought intimately into contact with the sensing waveguide 13 at discrete locations. These locations are defined by the geometry of a microchamber 9 and microchannels 12 in the microstructure D. An analyte input means 10 and an analyte output means 11 are shown schematically without detail. As the analyte is introduced into the microstructure D (for example in the form of a series of discrete plugs), it interacts with the sensing waveguide 13 and changes in the effective refractive index of the sensing waveguide 13 occur. These changes in effective refractive index lead to movement of the interference fringes. The interference pattern 8 is recorded by an array of photodetectors C and the change occurring in some or all of the fringes in the interference pattern may be measured. From this data, the phase shift is calculated.

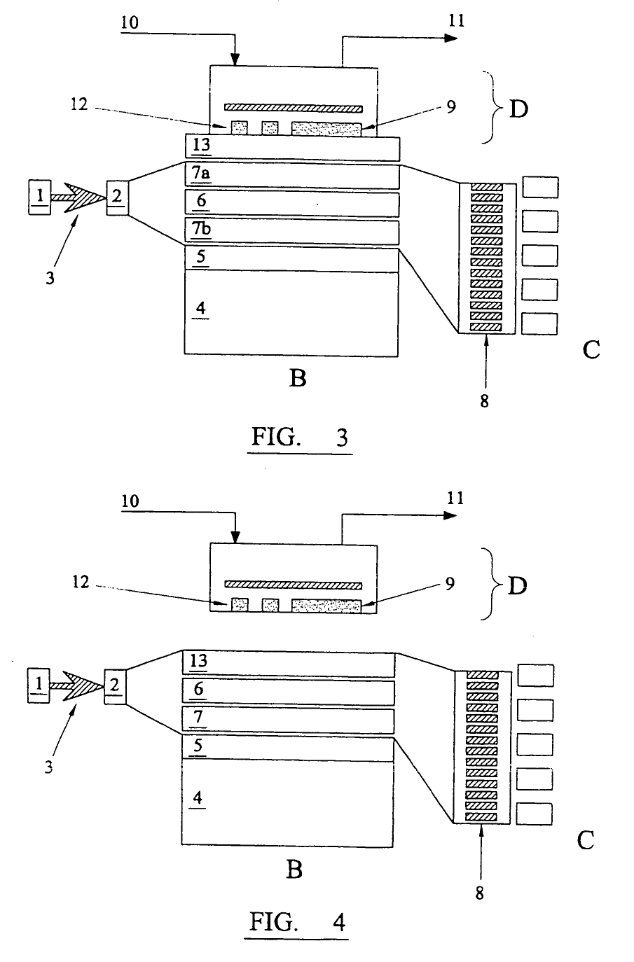

In FIG. 2, the sensor chip of FIG. 1 is shown schematically in plan view with details of the microstructure omitted so as to expose a view of the path of microchannels 12 and the position of the microchamber 9. Electromagnetic radiation 3 is shown passing through the sensing waveguide 13. Changes in the refractive index of material in the vicinity of the light path will effect changes in the dielectric properties of the sensing waveguide 13 and therefore of the output as discussed above. These changes may be caused by the introduction of (or changes in) an analyte in the microchamber 9 and the microchannels 12.

FIG. 3 illustrates a sensor chip B which is structurally similar to that of FIG. 1 but is deployed in evanescent mode.

Plane polarised electromagnetic radiation 3 is generated by an electromagnetic source (not shown). The electromagnetic radiation 3 is focussed using a lens 1 (or similar micro-focussing object) and oriented as desired using a polariser 2. The electromagnetic radiation passes into and through the multi-layered structure of the sensor chip B which in this embodiment comprises a silicon layer 4, silicon dioxide layers 5, 6 and silicon oxynitride layers 7a and 7b (acting as the secondary waveguide and reference secondary waveguide respectively). The evanescent component of the silicon oxynitride layer 7a acting as the secondary waveguide probes an absorbent layer 13 acting as the sensing layer and changes in the refractive index of the absorbent layer 13 effect the transmission of radiation through the silicon oxynitride layer 7a.

The electromagnetic radiation 3 is transmitted into the secondary waveguide 7a and the reference secondary waveguide 7b simultaneously. The layered structure of the sensor chip B is optimised so that the level of radiation entering the secondary waveguide 7a and the reference secondary waveguide 7b is approximately the same. Having passed down the multi-layered structure of the sensor chip B, the output radiation is coupled into free space thereby generating an interference pattern 8. The interference pattern 8 is recorded by an array of photodetectors C and the change occurring in some or all of the fringes in the interference pattern may be measured.

The sensor chip B and integral microstructure D allow an analyte containing stimuli of interest to be brought intimately into contact with the absorbent layer 13 at discrete locations. These locations are defined by the geometry of a microchamber 9 and microchannels 12 in the microstructure D. An analyte input means 10 and an analyte output means 11 are shown schematically without detail. As the analyte is introduced into the microstructure D (for example in the form of a series of discrete plugs), it interacts with the sensing layer 13 and changes in effective refractive index occur. These changes in effective refractive index are manifested as movement of the interference fringes. This movement can be readily measured using an array of detectors C which monitor the change occurring in some or all of the fringes in the interference pattern. From this data, the phase shift is calculated.

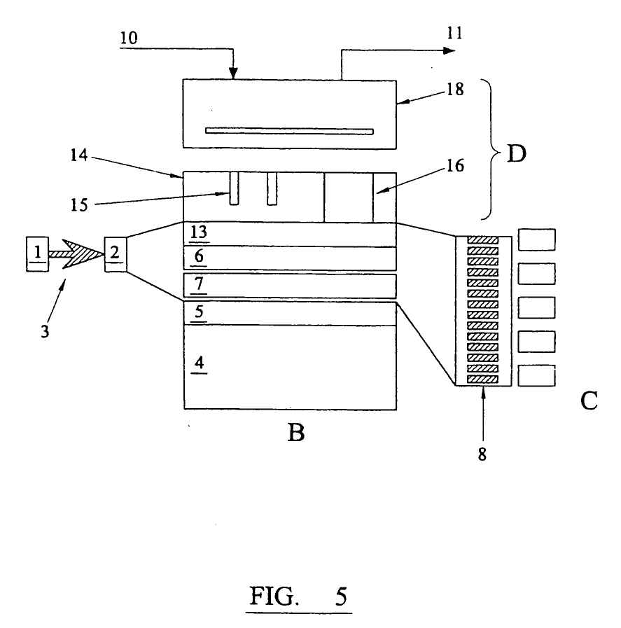

FIG. 4 illustrates a non-integrated sensor device with a sensor chip B and separate microstructure D in whole waveguide mode. It is otherwise structurally equivalent to the embodiment of FIG. 1.

A further embodiment of the sensor device of the invention is shown in FIG. 5 (in whole waveguide mode) in which the microstructure D is partially integrated onto the sensor chip B. In this embodiment, microchannels 15 and a microchamber 16 are integrated onto the sensor chip B in a cladding layer 14. The cladding layer 14 comprises a sol gel glass which is patterned using laser etching techniques or similar methods. The microchannels 15 are etched to a shallow depth to ensure that only the change in refractive index in the vicinity of the microchamber 16 is responsible for measurable changes in the sensor response. Additional functionality such as field generating structures (electrodes) may be added to the cladding layer 14 (or the non-integrated layer 18 of the microstructure D) where desired.

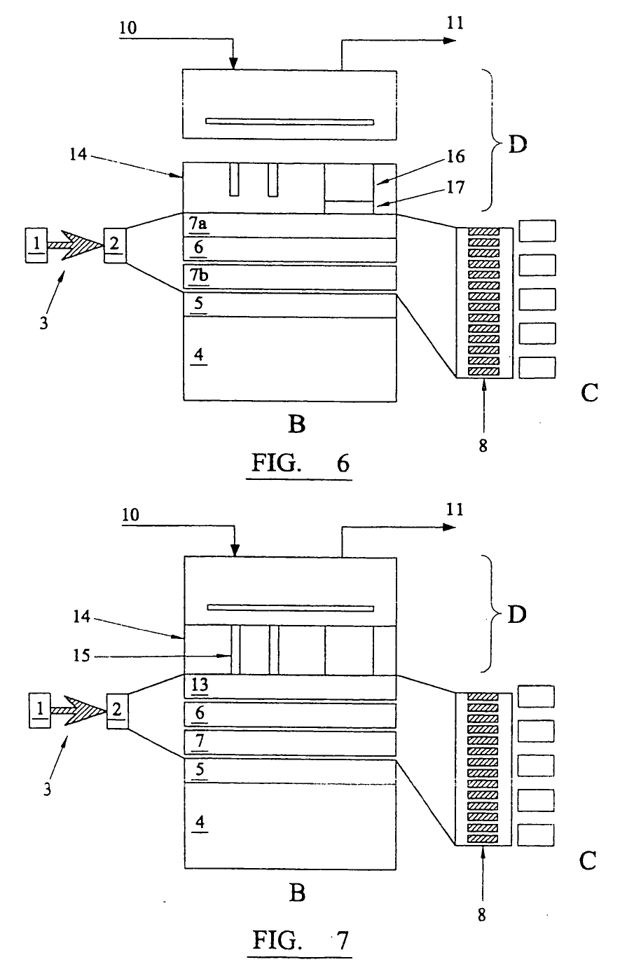

FIG. 6 shows a partially integrated sensor device similar structurally to that shown in FIG. 5 but operating in evanescent field mode. In this embodiment, an absorbent layer 17 lies at the exit end of the microchamber 16 in the cladding layer 14.

FIG. 7 shows an integrated sensor device similar structurally to that shown in FIG. 5 but in which the microchannels and the additional functionality are provided in a microstructure which is integrated onto the sensor chip B.

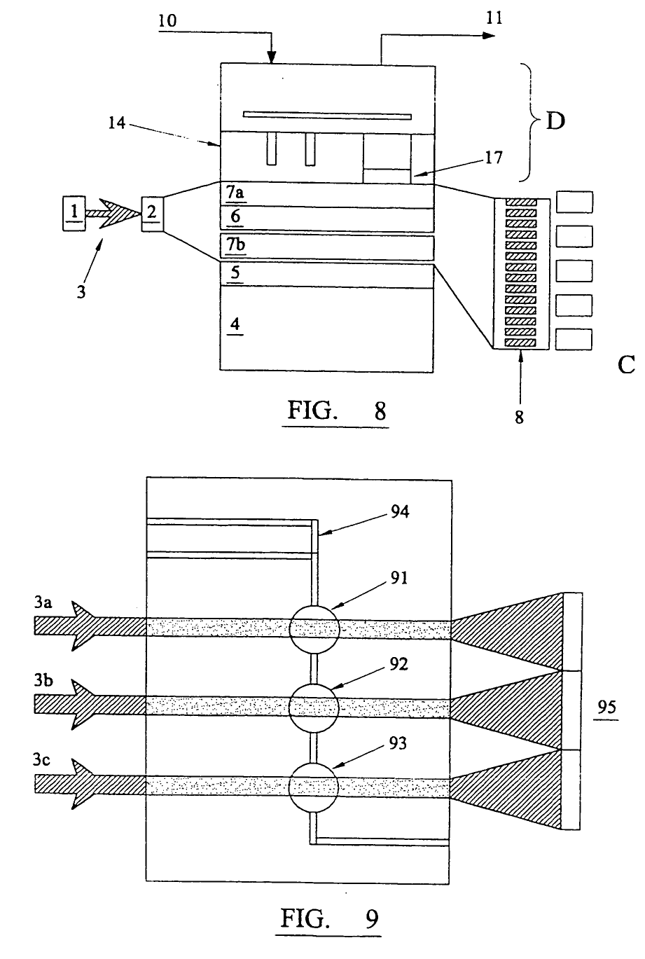

FIG. 8 shows an integrated sensor device similar structurally to that shown in FIG. 6 but in which the microchannels and the additional functionality are provided in a microstructure which is integrated onto the sensor chip B.

The invention permits discrete areas of a sensor device to be interrogated for the identification of the same or different stimuli. This is possible in one embodiment by utilising a number of radiation sources. An example of such a sensor device is shown in FIG. 9 with detail of microstructure omitted for clarity. A number of radiation sources 3a, 3b, 3c interrogate the same or different analytes at three distinct microchambers 91, 92, 93 which are interconnected by microchannels 94. The interference pattern is measured by an array of detectors 95.

1.-28. (canceled)

29. A sensor device for detecting the amount of or changes in a stimulus of interest in a localised environment, said sensor device comprising:
a sensor component including at least one of:
(1) at least one sensing layer and a secondary waveguide, wherein the sensing layer is capable of inducing in the secondary waveguide a measurable response to a change in the localised environment caused by the introduction of or changes in the stimulus of interest; and
(2) a sensing waveguide capable of exhibiting a measurable response to a change in the localised environment caused by the introduction of or changes in the stimulus of interest;
wherein each of the waveguides of the sensor component is a planar waveguide; and
a micro structure in the form of at least one of microchannels and microchambers positionable on the surface of and in intimate contact with the sensor component for intimately exposing at least a part of the sensing layer or the sensing waveguide to the localised environment.

30. A sensor device as claimed in claim 29 wherein the microstructure is integrated onto the sensor component.

31. A sensor device as claimed in claim 29 wherein the micro structure is capable of permitting the continuous introduction of an analyte containing a chemical stimulus of interest.

32. A sensor device as claimed in claim 31 wherein the microstructure is capable of permitting the continuous introduction of the stimulus of interest into the localised environment in a discontinuous flow.

33. A sensor device as claimed in claim 29 wherein the microstructure is capable of inducing chemical reactions in a static analyte containing a chemical stimulus of interest.

34. A sensor device as claimed in claim 29 wherein the microstructure is included in a cladding layer.

35. A sensor device as claimed in claim 34 wherein the sensing layer is incorporated in the cladding layer.

36. A sensor device as claimed in claim 29 wherein the secondary waveguide is made of one of silicon oxynitride and silicon nitride.

37. A sensor device as claimed in claim 29 wherein the sensor component includes a sensing waveguide capable of exhibiting a measurable response to a change in the localised environment caused by the introduction of or changes in the stimulus of interest.

38. A sensor device as claimed in claim 29 further comprising an inactive secondary waveguide in which the sensing layer is incapable of inducing a measurable response to a change in the localised environment caused by the introduction of or changes in the stimulus of interest.

39. A sensor device as claimed in claim 38 wherein the inactive secondary waveguide is capable of acting as a reference layer.

40. A sensor device as claimed in claim 39 wherein the secondary waveguide and inactive secondary waveguide are made of silicon oxynitride.

41. A sensor device as claimed in claim 37 further comprising an inactive waveguide substantially incapable of exhibiting a measurable response to a change in the localised environment caused by at least one of the introduction of and changes in the stimulus of interest.

42. A sensor device as claimed in claim 41 wherein the inactive waveguide is capable of acting as a reference layer.

43. A sensor device as claimed in claim 41 wherein the inactive waveguide is made of silicon oxynitride.

44. A sensor device as claimed in claim 29 wherein the sensing waveguide or sensing layer comprises at least one of an absorbent material and a bioactive material.

45. A sensor device as claimed in claim 29 wherein the sensor component comprises a multi-layered structure.

46. A sensor device as claimed in claim 45 wherein the multi-layered structure of the sensor component is fabricated onto a silicon substrate and comprises an absorbent layer capable of acting as a sensing layer located above and in intimate contact with a first silicon oxynitride layer capable of acting as a secondary waveguide, optionally together with at least one intermediate silicon dioxide layers.

47. A sensor device as claimed in claim 46 wherein the first silicon oxynitride layer is located above and spaced apart from a second silicon oxynitride layer capable of acting as a reference secondary waveguide by an intermediate silicon dioxide layer.

48. A sensor device as claimed in claim 45 wherein the multi-layered structure of the sensor component is fabricated onto a silicon substrate and comprises an absorbent layer capable of acting as a sensing waveguide, optionally together with one or more intermediate silicon dioxide layers.

49. A sensor device as claimed in claim 48 wherein the absorbent layer is located above and spaced apart from a first silicon oxynitride layer capable of acting as a reference waveguide.
